(19) United States
(12) Patent Application Publication
(10) Pub. No.: US 2004/0230672 A1
(43) Pub. Date: Nov. 18, 2004

(54) Methods and aparati for recognizing a pattern of using information units and generating a stream of information units in accordance with a recognized pattern

(76) Inventors: Mark Elliot Zuckerberg, Dobbs Ferry, NY (US); Adam Edward D'Angelo, Redding, CT (US)

Correspondence Address: R. Lewis Gable, Cowan, Liebowitz & Latman, P.C., 1133 Avenue of the Americas, New York, NY, 10036, US

(21) Appl. No.: 10/439,129

(22) Filed: May 14, 2003

(51) Int. Cl. H04N 7/16; G06F 15/177; H04H 9/00

(52) U.S. Cl. 709/222; 725/9; 725/10; 725/12; 725/14

(57) ABSTRACT

This invention relates to recognizing patterns in people's individual listening habits and creating streams of playback based on those listening patterns. This invention does this by observing what information units the persons use and calculating how much the person likes each information unit in their collection and what information units each unit uses in close proximity to it. This invention can be applied to both software and hardware MP3, CD, and other such media devices that would be recognized by one with knowledge in these arts. The invention can be used with such devices so that it learns the patterns of the person using that device.

### FIELD OF THE INVENTION

This invention relates to devices for monitoring the use of a plurality of information units, plays, songs, or the like, e.g., MP3, CD, tape players, radios and streaming digital audio players, to recognize patterns of use or play, whereby a stream of songs or information units may be automatically played or used, or the operator my select one or more songs or information units to be used.

### BACKGROUND OF THE INVENTION

Media players have traditionally behaved in a linear fashion, playing information units, e.g., music, songs, video clips and the like, according to some order pre-defined by either the media itself (in the case of pre-ordered media such as CDs), the player (in the case of some order-altering function such as random or reverse), or the user (in the case of custom playlists). However, media players never before had the ability to adapt to the styles of music preferred by their users. An object of this invention is to fulfill that role and enhance the listening experience of its users by providing streams of music based on their own habits and/or preferences.

In devising this invention that ultimately achieved its goal, several considerations were made. First, it was decided preferably to ignore the actual musical data behind the songs and consider the statistical data generated by the users' pertaining to what songs they played, when they played those songs, and how much of those songs were played. This way, all patterns found would be actual statistical patterns in the users' listening choices rather than patterns in the music they chose to listen to. Second, it was found preferable to do a broader analysis of users' listening patterns rather than many specific analyses. For example, one proposed approach would be to track what songs users preferred to hear at night versus the daytime, or on the weekend versus the week. Potentially, there might be too many such specific analyses to perform for the system to be feasible, and that performing a general analysis (calculating which songs the users liked globally) allowed for interpolation of these specific cases. Therefore, a general analysis was prepared and proved to be more accurate than a series of specific analyses.

A further object of this invention was also a consideration of both the theoretical and the practical. The first physical implementation of the system is already capable of supporting both software and hardware media players. The phrase media players includes but is not limited to MP3, CD, tape, radio, and streaming digital audio players. It is appreciated that this invention could be applied to any player supporting any media, including different audio formats or any number of video formats. Though this invention is described as monitoring and controlling the playback of music, it is appreciated that the invention may be used with a wide variety of information and/or data as would be appreciated by one skilled in the art.

### SUMMARY OF THE INVENTION

In accordance with the teachings of this invention, a method of recognizing a pattern of a plurality of information units is disclosed whereby each of the plurality of information units may be selected and used by at least one person. The method comprises the storing in a database each information unit selected and played by the one person, and ascertaining the degree that the one person likes each of the information units stored in the database. In particular, the method determines the degree of-likelihood that each stored information unit will be used at any given point in time.

In a further aspect of this invention wherein a second information unit is processed, the method includes the steps of determining the rate at which the one person's using pattern changes, of storing each of the plurality information units in the database as a chronologically-ordered log, and then weighting information units at different points in said chronologically-ordered log based upon the rate at which the one person's information unit using pattern changes.

In another aspect of this invention, the method determines whether the user uses or plays substantially all of the information unit and, if so, adds an amount of value to each sufficiently used information unit according to how much that the sufficiently used information unit is weighted by a function.

In a still further aspect of this invention, the method normalizes the values added to the information units stored in a chronologically-ordered log within the database by summing the amount of weighted values added to the stored information units, and of dividing the value of each of the plurality of information units by the sum of the weighted values added to all of the information units.

In a further aspect of this invention, wherein the method includes the steps of determining whether a given information unit is used with a few information units of the information unit being tracked and, if so, adding a value to such information units that reflects the degree of proximity of the given information unit to the tracked unit.

In another aspect of this invention, the method of recognizing a pattern of a plurality of information units includes the steps of storing in a database each information unit selected and played by at least one person, ascertaining the degree that the one person likes each of the information units stored in the database, and ascertaining at least one information unit that is played within a predetermined proximity of a tracked information unit that is stored in the database.

In a still further aspect of this invention, the method of controlling the use of a plurality of information units comprises the steps of facilitating at least one person to select an information unit, whereby the one person selects and uses the information unit, constructing a pattern of use of the plurality of information units, facilitating the use of at least one information as selected from the pattern of use of the information units, monitoring the selection of the plurality of information units, and constructing said pattern based only on the selection of the information units by the one person.

### BRIEF DESCRIPTION OF THE DRAWINGS

The forgoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIGS. 1A and B are respectively to a functional block diagram showing how a driver device relates to the use of a database and the user, and a high level flow diagram illustrating how the user device operates the driver device to communicate with the database and the user;

FIG. 2 discloses a medium level flow diagram of how data is generated from the driver device and how a pattern of use of information units is generated

FIG. 3 is a flow diagram representing the stream traversal mechanism of this invention, and discloses how the invention iteratively chooses each song for playing in the stream individually;

FIG. 4 is a flow diagram representing the value calculation mechanism of the invention, and discloses how the invention calculates and represents the global settings for its users' preference for each song or information unit;

FIG. 5 is a flow diagram representing the weight function calculation mechanism, and discloses how the appropriate decay function is calculated for use within the value calculation found in FIG. 2;

FIG. 6 is a flow diagram representing the proximity calculation mechanism, and discloses how the invention quantifies the proximity within which a given number of songs are generally played by a given user; and

FIG. 7 is a flow diagram showing how the invention responds to signals received from the driver device as shown in FIG. 1A to initiate the calculations of values and proximities to output a selected song or information unit.

### DETAILED DESCRIPTION OF A PREFERRED EMBODIMENT

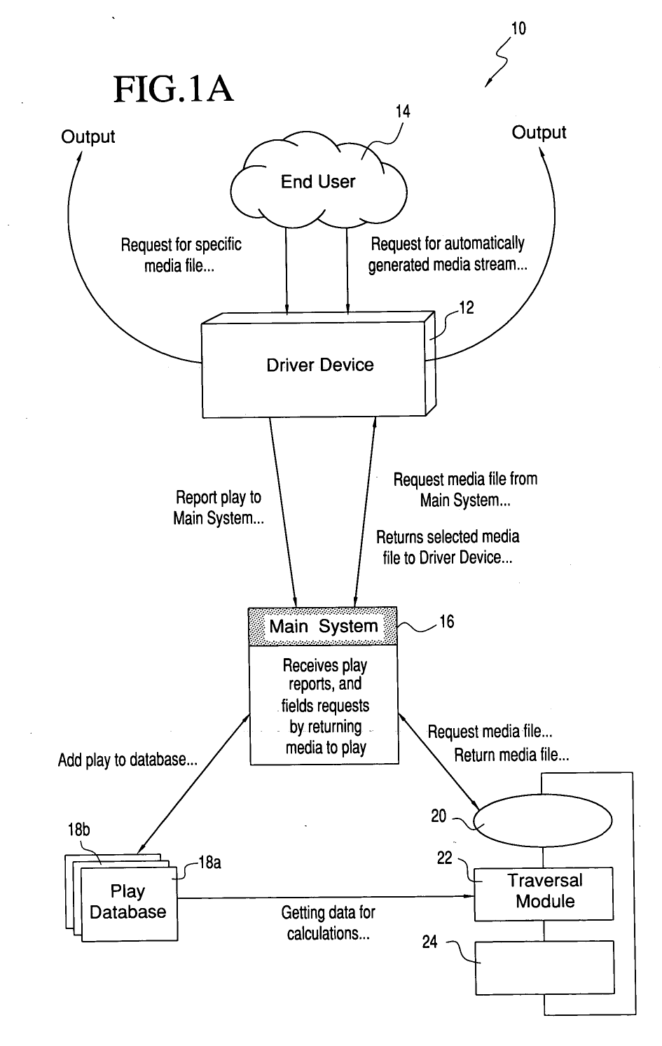

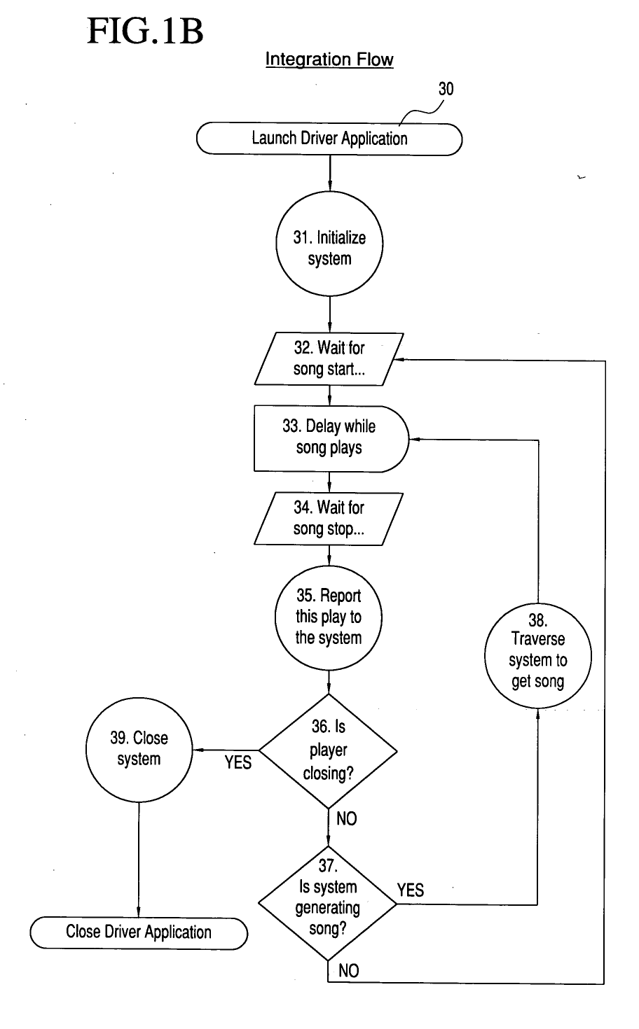

This invention does not have to be directly invoked by a user. Instead, as shown in FIG. 1A, this invention (10) is attached in one embodiment thereof to some third-party device as added functionality. This invention (10) illustratively includes a driver device (12). In the case of a media player, the user interacts with the driver device (12) to play media, which is generally referred to throughout this document as an information unit. The user either tells the device (12) to play a specific song or use a particular information unit, or if this information is attached to the device (12), the user can also request that the invention (10) automatically generate a stream of information units to be used or played.

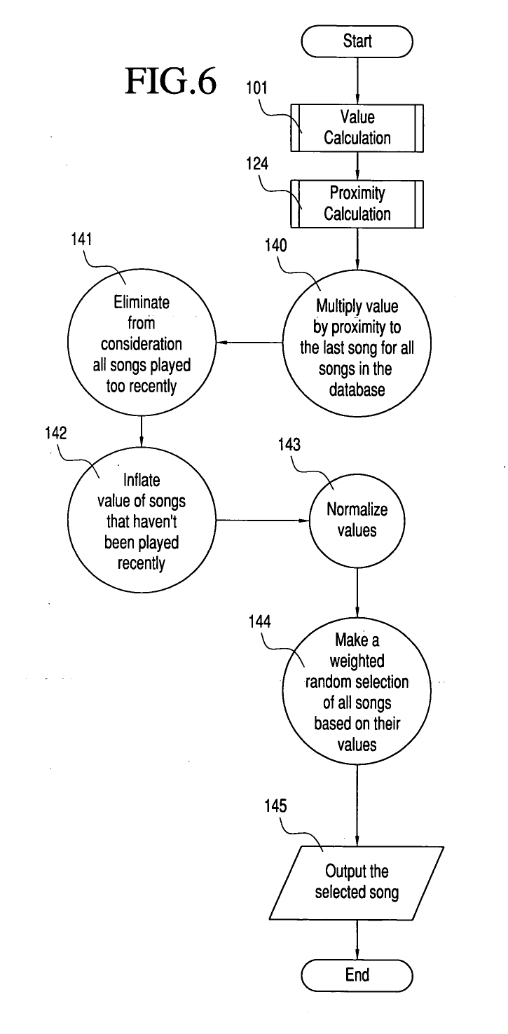

If the user requests a specific information unit, the device (12) plays it and creates the appropriate output for the user indicative of that use. Upon completion of the play, the device (12) reports that use to the invention's main interface (16), which in turn adds the play report to a use database (18). If the user requests of the device (12) that a stream be automatically generated, the driver device (12) then channels this request to the main interface (16), which runs the traversal module as will be described in detail with respect to FIG. 6. This module uses the data from the play or use database (18) to decide which information unit to use next. It then reports a file it has selected back to the main interface (16), which then reports the file back to the driver device (12). The device (12) can then play the specified media file and it creates the appropriate output.

There are also other illustrative embodiments for this invention (10) to get reports of plays in the driver device (12). In the method (10) outlined above and shown in FIG. 1A, the device driver (12) actually sends a report to the invention's main interface (16) to report plays or uses. However, the invention (10) can be implemented in such a way that it queries the driver device (12) at a very fast rate to see what kind of information unit is being used, and infers from changes when files are done playing and when it should add play reports to the play database (18). In every case, though, requests for automatically generated media streams must be sent to the system (10), either by some intermediate third-party device (12), or by the end user directly.

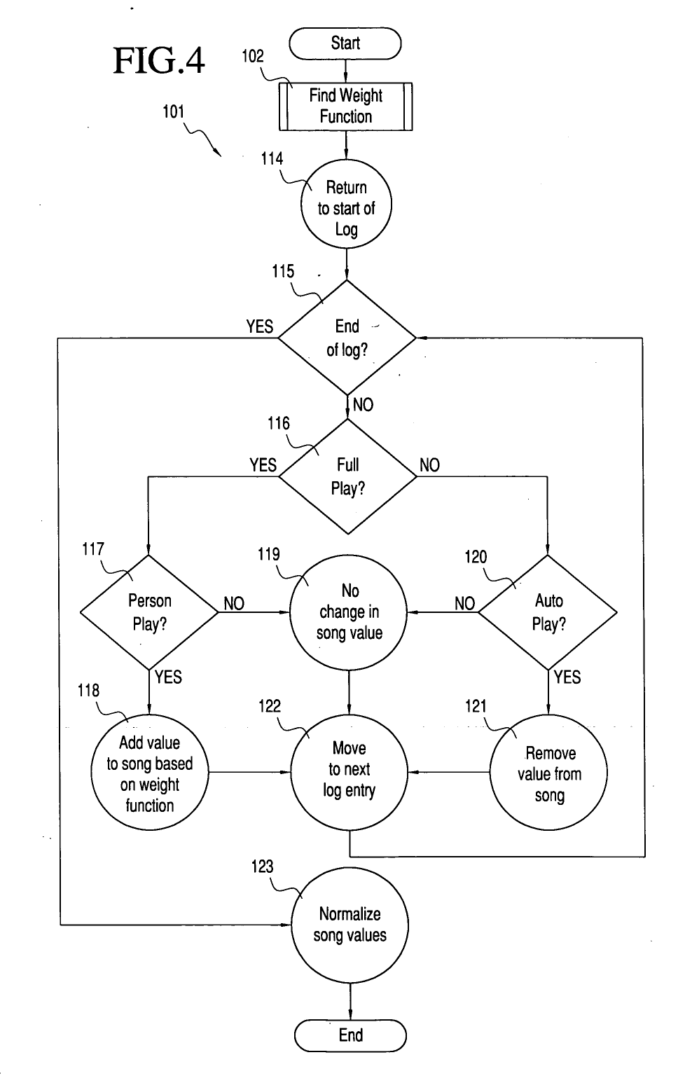

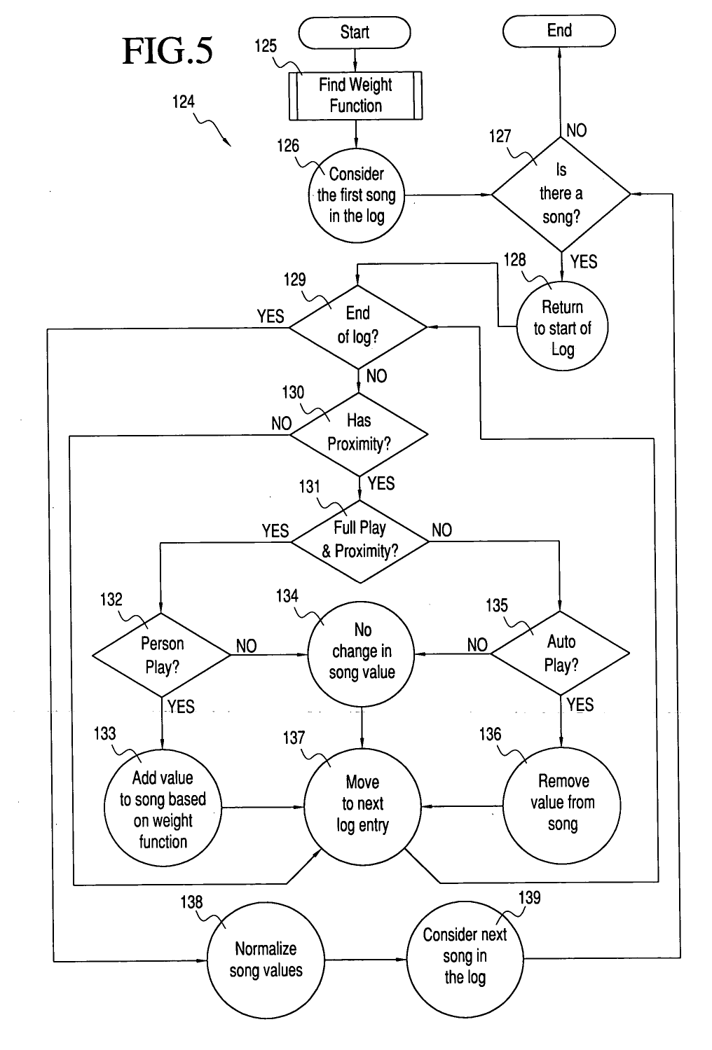

Referring now to FIG. 1B, the method of operating the driver device (12) (FIG. 1A) is shown. The invention (10) can be incorporated into any media system or information unit. As soon as the media system (10) is launched, the system (10) is initialized in step (31). This initialization includes the loading of plays (or uses) in the stored database (18), and performing preliminary value and proximity calculations as will be described below with respect to FIGS. 4 and 5. Once the initialization has completed, the media system (10) waits in step (32) for input from the user. This input takes the form of the user telling the system 10 to begin playing a media file or information unit. While the file is playing, the system (10) waits and takes no action in step (33) and the media system continues playing the file. When the file play ends in step (34), which can be because the file has played in its entirety, the user has stopped it manually, or the user has tried to close the media system, the play is reported in step (35) to the system (10). This report comprises the following four pieces of information: 1) the file played, 2) the percentage of the file played, 3) the time at which the report was filed, and 4) a play or use type identification number. The final field is a number that differentiates between plays or uses chosen by the user and plays chosen by the system (10).

Still referring to FIG. 1B, once the report has been sent from the media system or driver device (12) to the system (10), the media system (10) checks in step (36) whether the user tried to terminate the play or use of the driver device. If terminated, the media system (12) invokes in step (39) a shutdown procedure in the system (10), which clears all data from the database (18), and then shuts itself down as well. If the user did not try to close the media system (12), then the system (10) checks whether a flag is set in step (37) which signals that the system (10) is selecting songs. If this flag is set, the media system (12) then enables the system (10) to perform its traversal and return in step (38) the next song to be played. The driver device (12) then begins playing this song and the system (10) waits while it plays in step (32) and the process is repeated. If the system (10) is not set to select songs, then the media system waits until the user selects in step (32) another song to be played and then the system moves forward from there.

To illustrate the method this technology employs, it is helpful to simplify the field of potential people it can be applied to down to a single person, since it operates on each person individually. Thus, it will be explained in the context of an illustrative embodiment of this invention, wherein the invention recognizes the listening patterns of at least one person.

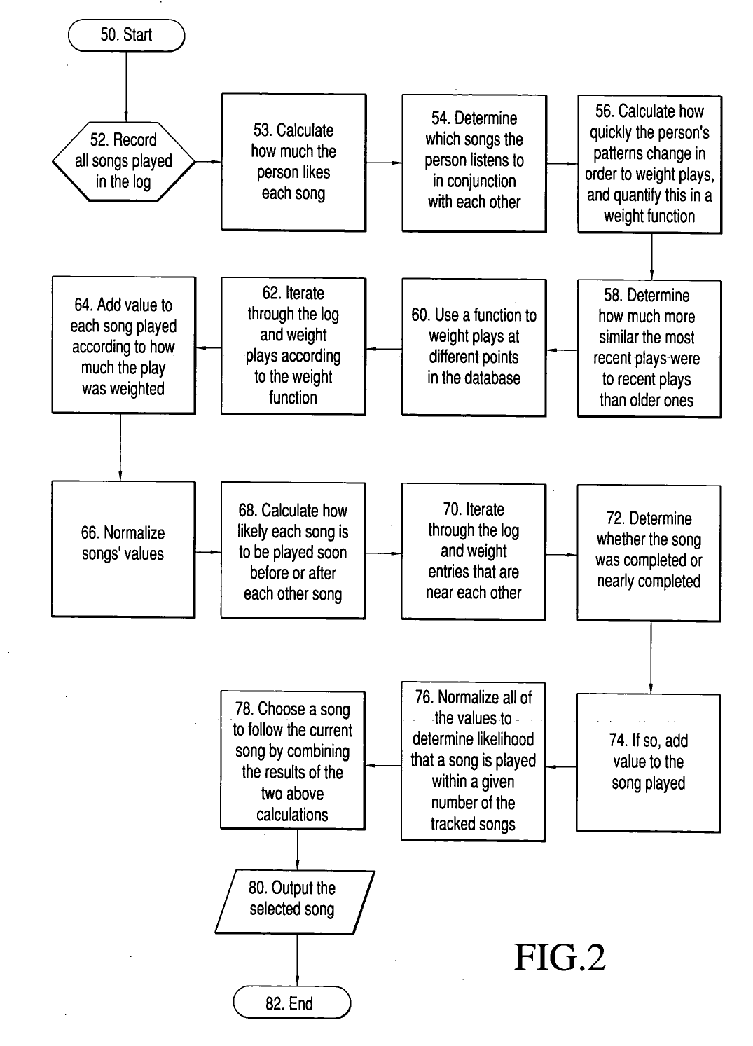

Referring now to FIG. 2, this invention begins by recording in the database (18) (FIG. 1A) in step 52 every song the person has played, at what time each song is played, and how much of each song is played in a chronologically-ordered log. Based on the database (18) (FIG. 1A) of song plays, it performs two different operations to compute the person's listening patterns. The first is to calculate in step (52) exactly how much the person likes each song in the database (18), and the second is to figure out in step (54) what songs in the database the person listens to in conjunction with each other.

To facilitate the calculation in step (52) of how much the person likes each song, a unit of measure for expressing how much a song or information unit is liked is defined. The percent chance each song has of being played at any given point in time is used as this metric. The calculation of these values uses its own involved method. To do this, the method calculates in step (56) how quickly the person's listening patterns change so it knows how to weight plays inputted later in the database, which are the more recent plays, versus plays earlier in the database, which are the plays that happened a longer time ago.

In order to know how to weight the plays, this invention performs in step (58) a calculation to see how much more similar the most recent plays were to relatively recent plays than to relatively older plays. Based on this calculation, the invention employs in step 60 a function which tells it how to weight plays at different points in the database.

With this weight function, the invention iterates in step (62) through the database and looks at each entry. If the song in the entry being examined was played in full or nearly in full (it recorded how much of each song was played for this step), then it adds value in step (64) to the song played according to how much that play was weighted by the function derived above. When the iteration is complete, each song that appears in the database has a certain amount of value, which is equal to the sum of the weighted values of its complete or nearly complete plays. Once it has all of these values, the invention normalizes in step (66) the value by dividing each song's value by the total amount of value points awarded to all songs in the database. For example, if some song had 20% of the total points awarded, then its normalized value would be 20%=0.2. These normalized values represent how likely each song is to be played, and therefore, represent how much the person likes each song.

Next, just like how likely each song is to be played is defined as the metric for how much the person likes each song, how likely each song is to be played in step (68) near every other song determines what songs the person generally listens to in conjunction with what other songs. For this calculation, the invention weights in step (78) the plays in the database, so another weight function is used. For simplicity, since the database (18) is the same as before, which means that the person's listening patterns are changing at the same rate as before, it can use the same weight function derived above.

Using the weight function, the invention iterates in step (70) through the database (18) for each song in the database. Every time it passes through the database, at each entry, the invention checks in step (72) to see if the song played was played either completely or nearly completely and if the song was played within a few songs of the song it is tracking proximity to. If these conditions are met, then the invention adds in step (74) value to the song played based according to how much that play was weighted by the function, and exactly how many songs the song played was away from the entry where the song played was the song we are tracking proximity to. At the end of each loop through the database, the invention normalizes in step (76) all of the values like it did in the first calculation, and thus the invention provides the percent chance that each song has of being played within a few songs of the song being tracked. When this procedure has been completed for each song in the database, the invention then knows how likely every song in the database is to be played within a few songs of every other song.

These two calculations, which are called the value and proximity calculations respectively, provide information sufficient to create streams of music based on the person's listening patterns.

Since streams of music can be unending, the invention figures out what song to play one at a time to ensure that the stream continues as long as the person wants it to. Choosing songs to play based on what was last played and how the person received that song (whether they decided to let it play or skipped it) provides a dynamic method of creating playback. Thus, it needs to be able to figure out what song to play next, dependent on what was last played.

To figure out what song to play next in a stream of playback, the invention combines in step (78) the two types of data it has computed. What the person ideally wants to hear is a combination of what songs the person really likes and what songs that person would usually listen to around the last songs played. To do this, the invention multiplies the value rating of each song by the rating of that song's proximity to the last song played. In this way, a song which is both well liked by the person and often listened to within a few songs of the last song will have the highest combined value, while songs that are just liked by the person or just often listened to within a few songs of the last song will have somewhat lower combined values. Then, the invention normalizes all of these values so that each song has just one value-its chance of being picked to be played next. Since the values are normalized, the sum of the values of all of the songs will add up to 100%. The invention then chooses a random number, which will correspond to the song that will be played next. The random number is weighted, however, so that a song with a 40% normalized value has a 40% chance of being picked as the random number, and so on.

At this point, it is important to note that there is difference between plays chosen by the user and plays chosen by this method in the database of plays. This distinction is important because value points are given out in both calculations only when the song was chosen by the person. A system of negative feedback is implemented for songs that this invention selects, so that if the person stops a song, or does not listen to nearly all of it, that was selected by the invention, then that song actually loses value according to the weight assigned by the weight function. This separation of manual plays and automatic plays prevents our method from falsely re-enforcing itself and enables this invention to distinguish between what the person's patterns actually are and how we approximate them, even though the two will most likely be very similar.

Using this method, the invention can output in step (80) the selected song to create unbounded streams of music based on the person's listening patterns, which include how much the person likes each song and what songs the person usually listens to in conjunction with what other songs.

This invention is directed in one illustrative embodiment to an automatic stream generation of media. The system analyzes a given user's listening data once it has been collected in the appropriate format. The formats used for storing such data include but are not limited to delimited logs and relational databases. For this illustrative embodiment of the invention, the data is assumed to be organized in a log comprising of four fields: the time at which the entry was reported, the song corresponding to the entry, the percentage of the song completed for the entry, and the type of entry. For efficiency, all of these fields can be filled by integers which reference the appropriate values in another location. It is further assumed for simplicity, but without departing from the teachings of this invention, that only one log file can be read at a time. From this point forth, the “head” will be used to refer to a virtual mechanism that is at the particular log entry being read at any point in time. This data implementation will be referred to implicitly in the system detailed below.

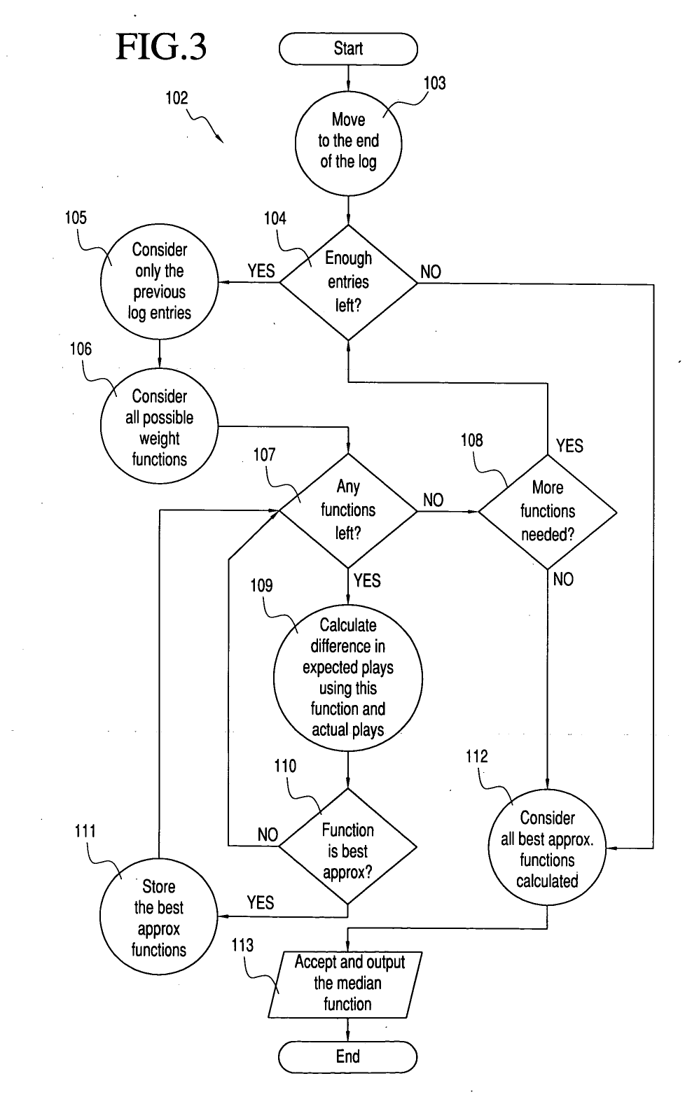

The method begins by analyzing the log of reported entries. Referring now to FIG. 6, the method of analysis has two main facets: a process (101) of value calculation and then a process of (124) the proximity calculation. The value calculation process (101) is shown in detail in FIG. 4, and the proximity calculation process (124) is shown in detail in FIG. 5. The main method is shown in FIG. 3.

In FIG. 4, the value calculation process (101) begins by finding the appropriate weight function process (102) for the given data. The weight function is used to determine how much to consider different portions of the data. The weight function calculation process (102) is shown in greater detail in FIG. 6.

A “window” of entries is defined as a group of consecutive entries. In this illustrative embodiment, it is assumed that the window size is 100 entries without loss of generality. It is also possible to define “consecutive” windows as a group of windows in which the last log entry in each window directly precedes the first entry in the next window.

Referring now to FIG. 3, the weight function calculation process (102) begins in step (103) by moving the head to the end of the log, where the most recent entries are. Once the head is in this position, the method checks in step (104) to see if there are enough entries remaining before the front of the log to fit in a window. If there are enough entries for a window, the method puts in step (105) them into a window that temporarily considers only those entries prior to the start of that window. From here, the method considers in step (106) many possibilities for weight functions. These functions could illustratively be polynomial, logarithmic, or exponential in nature, and do not necessarily need to be defined explicitly in order to be considered. For example, a binary search could be implemented to consider a certain density of functions whereas it will implicitly rule out many functions within the specified function domain. Once the functional possibilities are specified, the system checks in step (107) if any of the functions still need to be tested. If so, the method takes in step (109) one of the functions that needs to be tested and runs the approximation test on it. The approximation test comprises the calculating of the absolute value of the difference between the expected plays predicted by applying the tested weight function to the temporarily considered log data and the actual plays in the currently considered window. Step (109) generates a number representing how accurately that function reflected the actual weight of the data over that span in the log. The lower the number, the more accurate the weight function. Once the test has been completed, the method checks in step (110) if that function produces the best approximation by comparing the result of the test with the best result of the test to that point. If this function is the best, the method stores in step (111) it as the best approximation for that window. At this point, the method returns to checking in step (107) if any functions need to be tested, and if none do, then the method checks in a step (108) if more weight function approximations are needed. This is a subjective matter. In this illustrative embodiment, “enough” weight function approximations are defined as the best results from a number, e.g., five such tests, although more tests could be conducted without departing from the teachings of this invention. If more functions are needed, then the method checks in step (104) to see if there are enough entries in the log for another window. If no more functions are needed, or there are not enough entries left to form another window, the method considers in step (112) all of the best approximation functions generated. Then step (113) accepts the median of these functions as the optimal approximation and defines the median as the weight function to be used throughout the system.

Once the weight function has been calculated in process (102), the method as shown in FIG. 4 resumes the value calculation process (101) by returning in step (114) the head to the beginning of the log. Then step (115) checks to see if the head is at the end of the log. This is not an important step the first time through, since the condition would only return negative if the log were empty, but it is an important iterative step for later on. If the head is not at the end of the log, then the method looks in step (116) at the current entry and first considers the percentage of the song completed and whether the entry represents a full play of that song. In this illustrative embodiment, a full play or use is defined by a percentage of song or information unit completed greater than or equal to 80%, although this portion can be changed without departing from the teachings of this invention. If the entry is a full play, the method then checks in step (117) whether the entry represents a song played by a person. To gather this information, the log field pertaining to the type of entry is considered. It is necessary to assign different values to plays by people and plays by this invention in this field. If the song was played by a person, then value is added in step (118) to the song in the entry according to the weight function. Thus, for any entry that meets these criteria, an amount of value will be added to the song listed in the entry equal to n*W(t), where W is the accepted weight function whose range is given by {t:0≦W(t)≦1}, t is the zero-indexed entry number of the current entry divided by the total number of entries in the log, and n is the number of times the song listed in the entry has been played within its predicted period.

According to the amount of value a song has at any particular point, the system can give an exact numerical representation of how many songs should be played within a predetermined number of plays of that song, e.g., 2. This amount of time is defined as the song's period. If, for example, a song's period is 20 and it is played 25 songs after it was played previously, then this new play that takes place 25 songs later is not within one period of the last time the song was played. Therefore, it is the first time the song was played within that period, so n=1. If, however, the play took place only 15 songs after the first play, then the play would have taken place during the first play's period, meaning that the new play is the second play within that period, so n=2.

Returning to value addition, essentially, a number of value points between zero and one inclusive will be added to the song as deemed appropriate by the explicitly defined weight function. If the song was not played in step (117) by a person, step (119) makes no change in the value of the song. If on the other hand the entry is not a full play or use as determined in step (116), then step (120) checks to see if the song was played by the invention itself. If so, as decided in step (120), a fraction of the song's value is removed in step (121) such that v′=v*0.9ⁿ, where v′ is the new value of the song, v is the previous value of the song, and n is the number of consecutive non-full, non-person-chosen plays of the song listed in the entry. An exception to this rule is when a period of a certain amount of time elapses after a non-full automatic play, since this very likely represents the user leaving the media player for some reason, in which case it is inaccurate to penalize the song.

No matter what the entry, when it is done being parsed, the method of this invention moves in step (122) the head to the next entry. When there are no more entries as decided in step (115), the method normalizes in step (123) all of the songs' values. In particular, step (123) sets each song's value equal to that song's aggregate value divided by the total number of value points assigned to all songs. In this way, the songs' new values represent what percent of the total value they had. These new song values are the accepted final values of the songs.

Once the process (101) of value calculation is complete, the method performs the process (124) of proximity calculations as shown in FIG. 5. The proximity calculations are similar to the value calculations carried out by process (101), as shown in FIG. 4, in that each process requires iteration through the log. The main difference between the two calculations is the amount of data generated. The value calculations generates one value for each song or information unit in the log, whereas the proximity calculations generates one value for each song for each other song in the log. Alternatively, if there are n songs in the log (NB songs are not the same as entries), n values are generated by the value calculation, while around n² values are generated by the proximity calculations. This is because each song has just one value, but each song has a certain proximity to each other song in the log.

Referring now to FIG. 5, the process (124) of proximity calculations begins by finding in step (125) an appropriate weight function, appreciating that step (125) need not be done again if it was already done during the process (101) of value calculations. The process (124) starts the calculations by moving in step (126) the head to the beginning of the log. Similar to the value calculation process (101), process (124) then checks in step (127) to see if the head is at the end of the log. If it is not as decided in step (127), meaning that there is a song or information unit at the current position, then the process (124) stores in step (128) this song as the reference song for the current iteration and returns the head to the start of the log. The process (124) again checks in step (129) if the head is at the end of the log to end this iteration. If it is not as determined in step (129), then the process (124) checks in step (130) whether the current entry is within a certain proximity of any play of the reference song. For this illustrative embodiment, the proximity used is three full plays, although this number can be changed without departing from the teachings of this invention. If the entry is within the proximity, the process (124) then checks in step (131) whether the entry is a full play. If it is, then the process (124) checks in step (132) to determine if the song listed in the entry was played by a person. If so, then value is added in step (133) to the proximity value between the reference song and the song listed in the current entry according to the weight function. The amount of value added to the proximity value is equal to p*W(t), where W is the accepted weight function whose range is given by {t:0≦W(t)≦1}, t is the zero-indexed entry number of the current entry divided by the total number of entries in the log, and p is the proximity constant for the distance between the nearest play of the reference song and the current entry. When the two entries are as close as possible—that is, one entry apart—it is intuitive that p=1. At the proximity threshold—the furthest away two entries can be and still be considered to be within the certain proximity of each other—it also makes sense that p approaches zero.

Returning to the process (124) of FIG. 5, if the song was not played by a person, then step (134) makes no change in the proximity value. Returning to the prior steps, if the entry was not a full play but the song was selected automatically by the step (135), then value is removed in step (136) from the proximity value between the reference song and the song listed in the entry according to the same devaluation formula used above for the value calculation in step (136). Regardless of how the conditions turn out, the process (124) ends up moving in step (137) the head to the next log entry when the actions are complete. At this point, if the head is at the end of the log as determined in step (129), the process (124) stops iterating through the log for the given reference song and normalizes in step (138) the proximity values relating to the reference song. The normalized proximity values are the final accepted proximity values for that song. After any reference song's proximity calculation is complete, the process (124) considers in step (139) the next unique reference song in the log and repeats the process as long as such a unique reference song still exists as determined in step (127). Otherwise, the proximity calculations of process (124) are complete and the values accepted are final.

Referring now to FIG. 6, using the value and proximity processes (101) and (124), the method of this invention then combines the data by multiplying in step (140) the value by the proximity to the song listed in the most recent log entry. After step (140), the process has an array of possible songs to play next. However, the process does not want to play a song that has been played too recently in the log, so it removes in step (141) all songs that have been played too recently from the array. The qualifier “too recently” means in one illustrative embodiment of this invention that the song has been played within one period of its last play, where period maintains the definition it was given above. The next step (142), after removing all songs that have been played too recently, is to boost the songs that have not been played as recently as the system calculates that they should have. The boosted value is given according to the equation v′=v*2^{t/p}, where v′ is the boosted value of the song, v is the non-boosted value of the song, t is the number of full plays since the last full play of the song, and p is the period of the song. According to this illustrative formula, the effective value of the song doubles each time it is not played within its calculated period. Once these effective values have been calculated, the process normalizes them in step (143) and in step (144) randomly weights selected of all of the remaining possible songs. The song that is chosen by the weighted random function is the accepted next song, and this song is outputted in step (145) as the result of a call to the system.

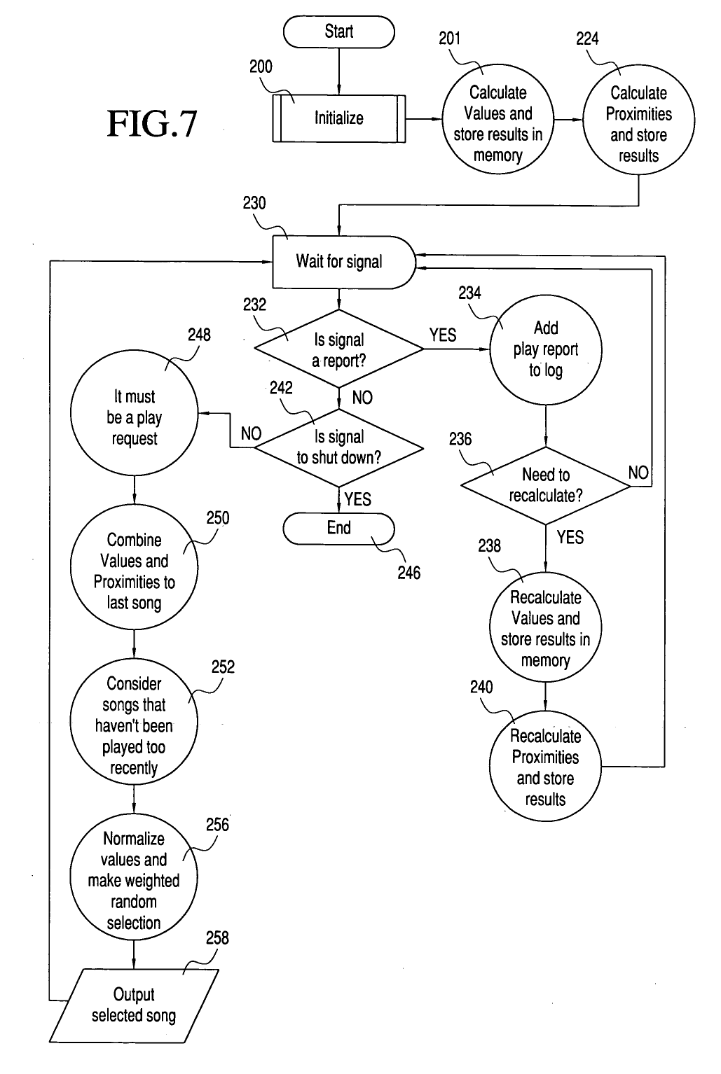

Referring now to FIG. 7, a preferred embodiment of this invention operates by receiving signals from a driver device (12) (FIG. 1A), such as a media player. When the invention is started up, it initializes itself in step (200) so that it is ready to receive signals. The initialization process (200) includes calculating the value of every song or information unit in the log and storing those values in memory (201), as well as calculating in step (224) the proximity of each song to every other song and storing those values in memory. When these steps are completed, the invention waits in step (230) for signals from the driver device (12). When a signal is received, the invention deals with it according to the conditions in steps (232) and (242). In step (232), the invention checks whether the signal is a report of a play.

If the signal is a report as decided in step (232), the invention adds in step (234) the play report to the log and then checks in step (236) how many plays have been added to the log since the last recalculation of values and proximities. In this illustrative embodiment, a state of “needing to recalculate” is defined as one in which 100 plays have been added to the log since the last calculation. If there is need to recalculate in step (236), the invention proceeds to step (238). Otherwise, it returns to step (230) and waits for another signal from the driver device (12). In step (238), the invention recalculates the value of every song in the log and replaces the previously stored values in memory with the new ones. Then, step (239) recalculates the proximity of each song to every other song and replaces those previously stored values in memory with the new ones as well. The invention then returns to step (230) and waits for another signal.

If the signal is not for a report as determined in step (232), the invention checks in step (242) whether the signal is to shut down the invention. If it is, the invention clears all data from memory and shuts itself down in step (246). Otherwise, step (248) determines that the signal must be a play request. The invention combines in step (250) the values and proximities to the last song to form an array of songs with raw possibilities of being played next. Next, step (252) narrows the list down to only those songs that have not been played too recently. With these songs, step (256) normalizes the values and makes a weighted random selection from the array or list of songs to be played. Then, step (258) outputs the selected song back to the driver device (12) and returns to step (230) where it waits for another signal.

This process continues until eventually a shut down signal is issued from the driver device (12), at which point the invention closes itself and the flow ends in step (246).

Benefits, other advantages, objects, and solutions to problems have been described above with regard to specific embodiments. However, the benefits, advantages, solutions to problems, objects, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. While a preferred embodiment of the present invention has been described, it should be understood that various changes, adaptations, and modifications might be made therein without departing from the spirit of the invention and the scope of the appended claims. For example, it will be appreciated that references to songs or plays also include video clips, information units and other data groups as would be recognized by one skilled in the art.

We claim:

1. The method of recognizing a pattern of using a plurality of information units by at least one person, each of the plurality of information units being selected and used by the one person, said method comprising the steps of:
a) storing in a database each information unit selected and played by the one person;
b) ascertaining the degree that the one person likes each of the information units stored in the database, said step of ascertaining comprises the substep of determining the degree of likelihood that each stored information unit will be used at any given point in time.

2. The method of recognizing a pattern as claimed in claim 1, wherein there is further included a step c) of determining for a given information unit stored in the database at least one other information unit that the person uses in conjunction with said given information unit.

3. The method of recognizing a pattern as claimed in claim 2, wherein said step b) of ascertaining includes a substep of determining the rate at which the one person's using pattern changes.

4. The method of recognizing a pattern as claimed in claim 1, wherein said storing step a) stores each of the plurality information units in the database as a chronologically-ordered log.

5. The method of recognizing a pattern as claimed in claim 4, wherein there is further included a step of weighting information units at different points in said chronologically-ordered log based upon the rate at which the one person's information unit using pattern changes.

6. The method of recognizing a pattern as claimed in claim 5, wherein said step of weighing comprises the substep of accessing at a first relative recent point in said and at a second relatively earlier point in said chronologically ordered log first and second information units respectively, determining a first degree of similarity between a third most recent information unit in said chronologically ordered loop and said first information unit and a second degree of similarity between said third information unit and said second information unit, determining the difference between said first degree and second degree to provide an indication of how much more similar the first more recent information unit is to said third present information unit than to said second relatively earlier information unit, and constructing based on how much more similar the first more recent information unit was to said third present information unit than to said second information unit a function to weigh each of said plurality of information units in the database.

7. The method of recognizing a pattern as claimed in claim 6, wherein each of the plurality of information units has a given length, and there is further included the step of measuring the length of use of each of the plurality of information units and, if greater than a predetermined portion of the given length of each information unit, a sufficiently used information unit is identified and an enabling signal is generated.

8. The method of recognizing a pattern as claimed in claim 7, wherein there is further included the steps of iterating through the chronologically-ordered log and, if the enabling signal is present, adding an amount of value to each sufficiently used information unit according to how much that the sufficiently used information unit is weighted by said function.

9. The method of recognizing a pattern as claimed in claim 8, wherein there is further included the steps of summing the amount of weighted values added to all of the sufficiently used information units, and of dividing the value of each of the plurality of information units stored in said chronologically-ordered log by the sum of the weighted values added to all of the sufficiently used information units to normalize the values of said plurality of information units stored in the database, whereby the normalized values represent how likely each of the plurality of information units is to be used.

10. The method of recognizing a pattern as claimed in claim 6, wherein each of the plurality of information units has a given length of use, and there are further included the steps of measuring the length of use of each of the plurality of information units, tracking the proximity of a given information unit with respect to an information unit being used, determining whether a given information unit is a predetermined portion of the given length of each information unit, determining whether the given information unit is used within a few information units of the information unit being tracked, and if the length of use of an information unit is greater than the predetermined portion of the given length of each information unit and if the used information unit is with the predetermined number of information units of information unit being tracked, generating an enabling signal.

11. The method of recognizing a pattern as claimed in claim 10, wherein there is further included the steps of iterating though the chronologically-ordered log, and if the enabling signal is generated, adding an amount of value to the given information unit being played according to the amount of the value of the information unit that was weighted to the function and to how many information units the tracked information unit was away from the entry where the information unit used was the information unit being tracked.

12. The method of recognizing a pattern as claimed in claim 11, wherein there is further included the steps of summing the amount of weight values added to all of the used information units, and of dividing the value of each of the plurality of information units stored in said chronologically-ordered by the sum of the weighted values added to all of the information units to normalize the values of said plurality of information unit stored in the database, whereby the normalized values represent how likely the information unit is to be used within the predetermined number of information units of the information unit that is being tracked.

13. The method of recognizing a pattern of a plurality of information units as selected and used by at least one person, said method comprising the steps of:
a) storing in a database each information unit selected and played by the one person;
b) ascertaining the degree that the one person likes each of the information units stored in the database; and
c) ascertaining at least one information unit that is played within a predetermined proximity of a tracked information unit that is stored in the database.

14. The method of recognizing a pattern as claimed in claim 13, wherein there is further included a step of generating a stream of information units in accordance with the recognized pattern of information units.

15. The method of recognizing a pattern as claimed in claim 13, wherein there is further included a step of determining the length of each used information unit.

16. The method of recognizing a pattern as claimed in claim 15, wherein there is further included the step of determining whether the length of an information unit to exceed a predetermined portion of the total length of use of the information unit.

17. The method of recognizing a pattern as claimed in claim 16, wherein there is further included the step of determining whether the length of the information units being played is greater that the predetermined portion of the total length and, if so, providing a value rating.

18. The method of recognizing a pattern as claimed in claim 17, wherein there are included the steps of summing the values associated with the length of information unites stored in the database, and generating in response to the summed values said pattern of selected and used information units.

19. The method of recognizing a pattern as claimed in claim 17, wherein there are further steps of determining the information unit being tracked is within a predetermined proximity to the information unit to the information proximity to the information unit being used and, if so, providing a value rating.

20. The method of recognizing a pattern as claimed in claim in claim 19, wherein there are further steps of iterating through the chronologically-ordered log, and if both a value rating and a proximity rated value of a particular information unit are provided, multiply the value rating and the proximity rating to provide an indication of the likelihood of being selected and used by the one person.

21. The method of controlling the use of a plurality of information units, said method comprising the steps of:
a) facilitating at least one person to select an information unit, whereby the one person selected use of the information unit is implemented;
b) constructing a pattern of use of the plurality of information units;
c) facilitating the use of at least one information as selected from the pattern of use of the information units; and
d) monitoring the selection of the plurality of information units and constructing said pattern based only on the selection of the information units by the one person.

22. The method of controlling as claimed in claim 21, wherein said monitoring step senses the selection by the one person of a particular information unit to modify the pattern of use by increasing the likelihood that the selected information unit is increased.

23. The method of controlling as claimed in claim 21, wherein said monitoring step senses that the one person interrupts the play of a particular unit to modify the pattern of use by decreasing the likelihood that the particular information unit is decreased.
